(19) United States
(12) Patent Application Publication
(10) Pub. No.: US 2017/0042363 A1
(43) Pub. Date: Feb. 16, 2017

(54) DRINK FILTER

(71) Applicant: John H. Frogge, Denver, CO (US)

(72) Inventor: John H. Frogge, Denver, CO (US)

(21) Appl. No.: 15/230,174

(22) Filed: Aug. 5, 2016

Related U.S. Application Data
(60) Provisional application No. 62/202,955, filed on Aug. 10, 2015.

(51) Int. Cl. A47J 31/06; B01D 27/06; A47J 31/08; B01D 27/04

(52) U.S. Cl. CPC A47J 31/0642; B01D 27/04; B01D 27/06; A47J 31/08

(57) ABSTRACT

A drink filter system and method are disclosed. The system has a disposable drink filter having a filter portion, a first flange coupled to the filter portion, and a handle. The system also has a reusable cartridge having a cartridge housing and a cartridge lid positioned on the housing, at least one of the housing or the lid having a second flange. The first flange is shaped and configured to align the filter relative to the cartridge. The handle is shaped and configured to enable removal of the filter from the cartridge. The second flange is shaped and configured to align the lid relative to the housing.

### CLAIM OF PRIORITY UNDER 35 U.S.C. §119

The present Application for Patent claims priority to Provisional Application No. 62/202,955 entitled “REPLACEMENT SINGLE-USE COFFEE FILTER” filed Aug. 10, 2015, and assigned to the Assignee hereof, the entire contents of which are hereby expressly incorporated by reference herein.

### BACKGROUND

Field

The present invention relates to improvements in filters for coffee or drink machines.

Background

Single-serve coffee machines and associated single-serve filters have become very popular in households and offices alike.

Two types of single-serve filters are currently available. The first of these is typically referred to as a “pod”. Pods are generally plastic cups with metallic lids sealed thereon, and are stored and delivered with coffee or other drink mixtures inside. When put in use, the coffee machine will pierce the pod, to allow water to filter through, thereby producing the drink. Each time a user prepares a cup of coffee (or tea or hot chocolate, etc.), he or she will use and discard a new pod, resulting in significant damage to the environment.

A second single-serve filter is also currently available. The second of these provides a reusable filter. The reusable filter may be filled to the users' preferred drink strength, and/or with the user's preferred drink, and has the advantage of significantly reducing the environmental impact of single-serve machines. However, the reusable filter is provided with a wire mesh that must be handled/cleaned between each use. This wire mesh, if touched too quickly after brewing, may burn the user's hand. Moreover, the cleaning process requires the use of a significant amount of time and water, thereby negating the positive environmental effects of moving away from a single use plastic pod. There remains a need in the industry for a filter system that is usable with a single-serve machine that does not have the adverse environmental impacts described above, reduces the likelihood of injury or discomfort for a user, and/or provides other new and innovative features.

### SUMMARY

In one example, a drink filter system is disclosed. The system may have a disposable drink filter having a filter portion, a first flange coupled to the filter portion, and a handle. The system may also have a reusable cartridge having a cartridge housing and a cartridge lid positioned on the housing. At least one of the housing or the lid may have a second flange. The first flange may be shaped and configured to align the filter relative to the cartridge. The handle may be shaped and configured to enable removal of the filter from the cartridge. The second flange may be shaped and configured to align the lid relative to the housing.

In another example, a method of filtering a drink is disclosed. The method may include placing a disposable drink filter in a housing of a reusable cartridge, the filter having a filter portion, a first flange coupled to the filter portion, and a handle. The exemplary method may also include moving the handle between a first position and a second position wherein at least a portion of the handle does not contact the first flange. The method may also include aligning a lid of the reusable cartridge to the housing.

In another example, a disposable drink filter for a drink filter system is disclosed. The disposable drink filter may have a filter portion, a first flange coupled to the filter portion, and a handle. The first flange may be shaped and configured to align the filter relative to a cartridge in the drink filter system. The handle may be shaped and configured to enable removal of the filter from the cartridge.

### BRIEF DESCRIPTION OF THE DRAWINGS

FIG. 1 is a front perspective view of a drink filter system in use;

FIG. 2 is a front perspective view of a coffee cartridge for the system in FIG. 1;

FIG. 3 is a perspective view of a drink filter for the system in FIG. 1;

FIG. 4 is a perspective view of the drink filter and a housing of the cartridge;

FIG. 4A is a perspective view of a drink filter for the system in FIG. 1;

FIG. 5 is a perspective view of the drink filter for the system in FIG. 1;

FIG. 5A is a perspective view of a drink filter for the system in FIG. 1; and

FIG. 6 is a flowchart of a method.

### DETAILED DESCRIPTION

Before describing various examples and embodiments in detail, a broad overview is first provided. In some examples, a modified drink filter and single serve system are disclosed. The single serve system may include a disposable drink filter and a reusable coffee cartridge. Importantly, the system 100 may reduce the amount of plastic placed in landfills through the use of single serve coffee machines, while simultaneously eliminating the requirement that a user empty and/or wash a metal mesh filter between uses. The system 100 may also reduce the chances of a user burning his or her hands on a reusable metal mesh filter as is currently the case in reusable drink filters, such as the Keurig reusable coffee filters known in the art.

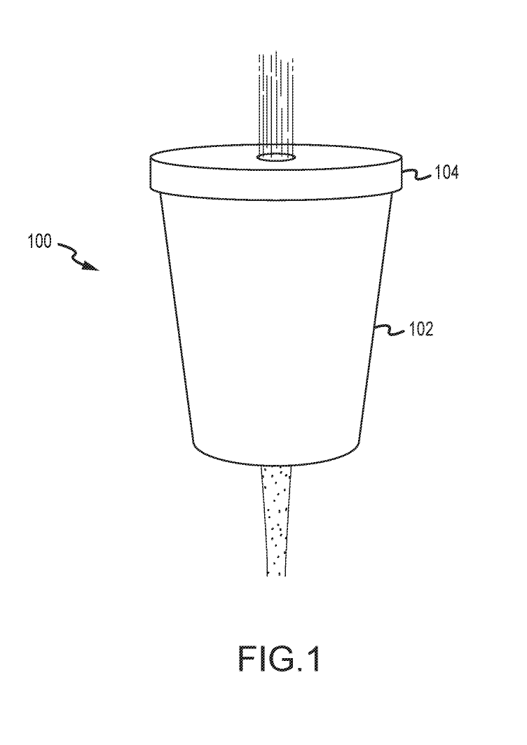

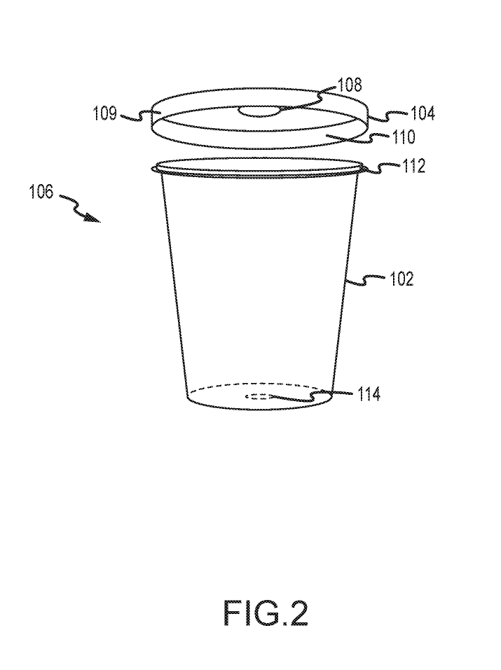

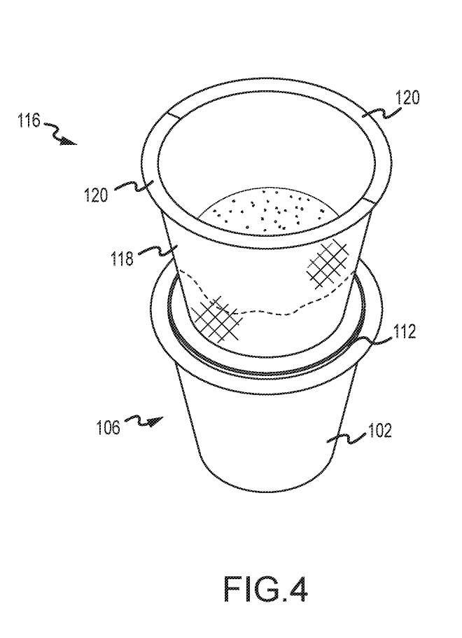

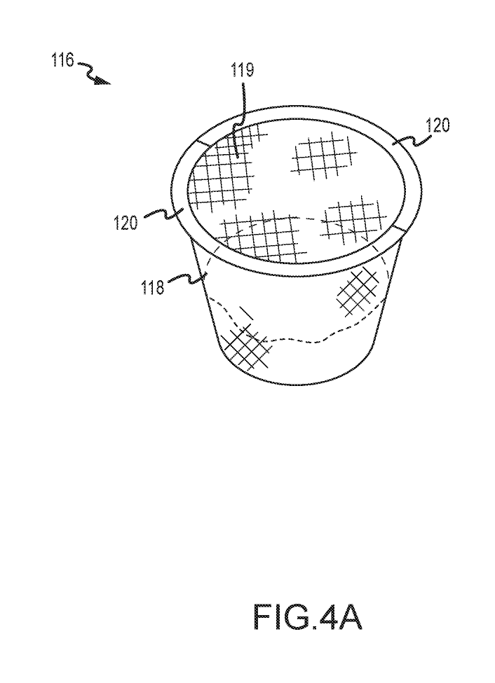

Referring now to FIG. 1, a perspective view of a drink filter system 100 is illustrated. The system 100 may include a reusable cartridge 106 (see FIG. 2) having a housing 102 and a lid 104. The housing 102 may be shaped to receive a disposable filter 116, as most clearly seen in FIG. 4.

With reference to FIG. 2, the cartridge 106 may have a housing 102 and a lid 104. The housing 102 and/or lid 104 may be made of plastic in some embodiments. The housing 102 and/or the lid 104 may be made of a non-biodegradable material, or any material suitable for repeated exposure to boiling liquids in some embodiments. In some embodiments, and as illustrated, the lid 104 may be removable from the housing 102. In some embodiments, the housing 102 or a portion of the housing 102 may be of a substantially cylindrical shape, or may be of a truncated conical shape, as illustrated.

In some embodiments, the housing 102 may have a bottom with a passage 114 for releasing coffee that has been filtered through the system 100 (see e.g. FIG. 1). In some embodiments, the lid 104 may have a passage 108 positioned to substantially align with the passage 114 in the housing when the cartridge 106 is assembled. In some embodiments, the system 100 may have a fluid entry passage 108 and a fluid exit passage 114, as illustrated in FIG. 2.

In some embodiments, the housing 102 may have a flange 112 shaped and configured to engage a portion of the lid 104 such as a side wall 109. In some embodiments, the flange 112 may be threaded, such as having a male thread, and may engage a threaded portion of the wall 109, which may have a female thread. Those skilled in the art will recognize that the flange 112 and wall 109 may be interchanged. In some embodiments, the housing 102 is substantially in the form of a truncated cone, and/or adapted to be placed in a single-serve coffee machine.

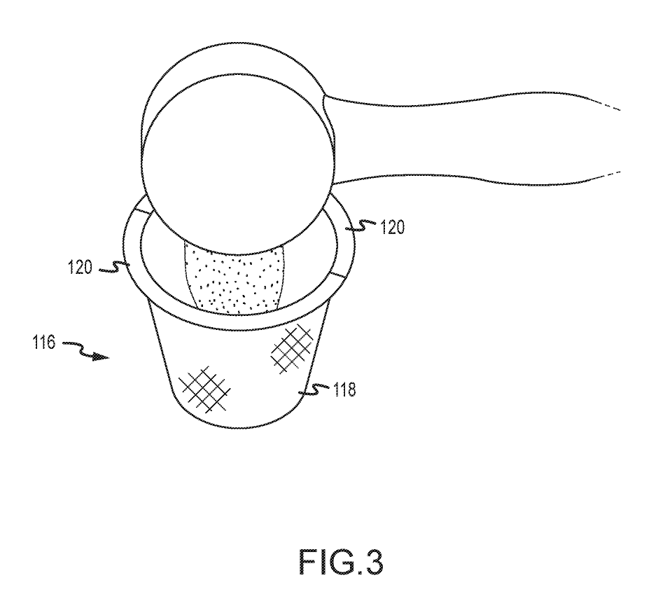

With reference now to FIGS. 3-5, the filter 116 may be disposable and in some embodiments have a filter portion 118 coupled to a flange 122. The flange 122 may be a lip on an upper portion of the filter portion 118, and may further be configured to align the filter 116 to the cartridge 106 or housing 102 of the cartridge 106 (see e.g. FIG. 4).

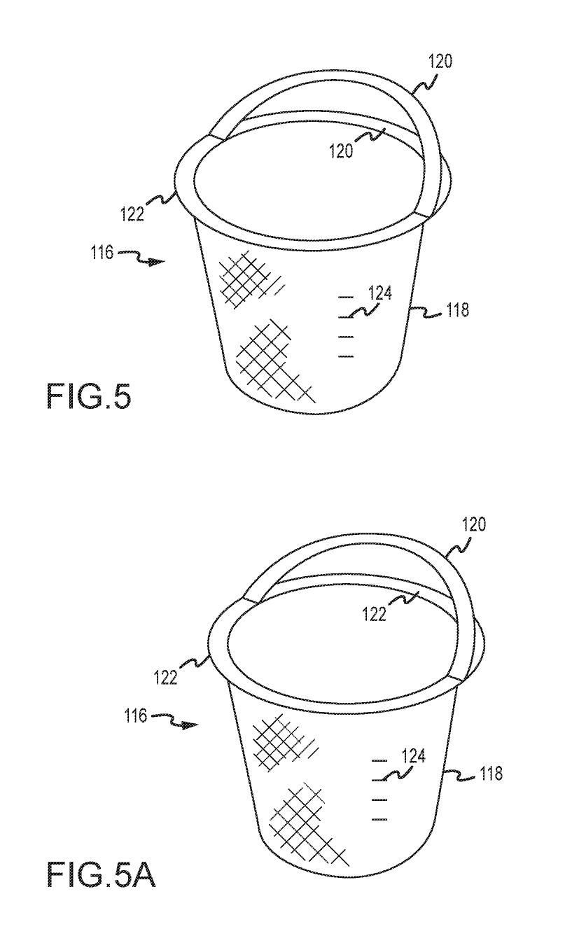

The filter 116 may have one or more handles 120 coupled to an upper region of the filter portion 118. For example, one or more handles 120 may be coupled to the flange 122. The one or more handles 120 may be movable relative to the flange 122 between a first position and a second position. In the first position, the handle(s) 120 may be positioned against the flange 122, as illustrated in FIG. 4. In the second position, the handle(s) 120 may be folded, pivoted, or moved away from the flange 122, as illustrated in FIG. 5. The flange 122 on the filter 116 may be referred to as a first flange, and the flange 112 on the housing 102 (or lid 104 if reversed) may be referred to as a second flange.

With continued reference to FIG. 5, the filter 116 may be configured to provide a user with an indication of a fill level. For example, one or more fill indicators 124 may be provided, such as on the filter portion 118, to give a user an indication of the level of coffee placed in the filter 116. In some embodiments, the indicator(s) 124 may be depression in the filter portion 118. In some embodiments, the indicator(s) 124 may be printed features on the filter portion 118. In some embodiments, the indicator(s) 124 may indicate a maximum acceptable fill level. In some embodiments, the indicator(s) 124 may indicate various fill levels suited for matching users' preferences for a variety of strength coffees. In some embodiments, the indicator(s) 124 may indicate various fill levels, such as a first fill level suited for coffee and a second fill level suited for hot chocolate or tea, for example.

As previously stated herein, the system 100 may be configured for use with a single-serve coffee machine. In some embodiments, the system 100 may be configured to hold a maximum of 6 teaspoons of ground coffee, tea, cocoa mix, or any other ground or powdered ingredient for a heated drink preparation. In some embodiments, the system 100 may be configured to hold a maximum of 4 teaspoons of ground coffee, tea, cocoa mix, or any other ground or powdered ingredient for a heated drink preparation. In some embodiments, the system 100 may be configured to hold a maximum of 2 teaspoons of ground coffee, tea, cocoa mix, or any other ground or powdered ingredient for a heated drink preparation.

With continued reference to FIG. 3, the filter 116 may be disposable in some embodiments. The filter 116 may be made of an organic material, a cloth, and/or a paper. In some embodiments, the filter portion 118 is made of crêpe paper. In some embodiments, the flange 122 and/or handle(s) 120 is/are made of paper. In some embodiments, the filter 116 is biodegradable.

In some embodiments, the filter 116 is substantially in the form of a truncated cone, and/or adapted to be placed in a single-serve coffee machine or in a cartridge 106 having a truncated cone shape.

In some embodiments, and as most clearly illustrated in FIG. 4A, the filter 116 may additionally include a cover 119. The cover 119 may be provided on filters 116 or systems 100 that are delivered pre-filled from a manufacturer or distributer. A portion or all of the cover 119 may be removable, such as by tearing away from the flange 120 or filter portion 118. In some embodiments, the cover 119 may be made of crêpe paper, an organic material, a cloth, a paper, and/or a biodegradable material. The cover 119 may be configured to tear at a preferred location. The cover 119 may be coupled to or unitary with the filter portion 118, and/or the cover 119 may be coupled to or unitary with the flange 120.

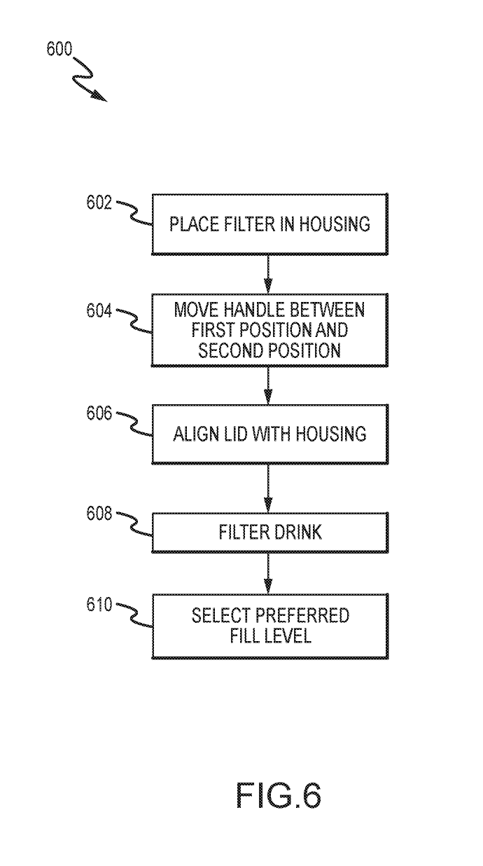

Turning now to FIG. 6, a method 600 of filtering a drink is now discussed in detail. The method 600 may include placing 602 a disposable drink filter in a housing of a reusable cartridge, the filter having a filter portion, a first flange coupled to the filter portion, and a handle. The method 600 may also include moving 604 the handle between a first position and a second position wherein at least a portion of the handle does not contact the first flange. The method 600 may include aligning 606 a lid of the reusable cartridge to the housing. The method 600 may include filtering 608 a drink, such as a single-serve drink, through a single-serve coffee machine. The method 600 may also include selecting 610 a preferred fill level. The method 600 may be achieved using a filter 116, a cartridge 106, or filter system 100 as previously disclosed herein with reference to FIGS. 1-5.

Each of the various elements disclosed herein may be achieved in a variety of manners.

This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, by way of example only, the disclosure of a “filter” should be understood to encompass disclosure of the act of “filtering”—whether explicitly discussed or not—and, conversely, were there only disclosure of the act of “filtering”, such a disclosure should be understood to encompass disclosure of a “filtering mechanism”. Such changes and alternative terms are to be understood to be explicitly included in the description.

The previous description of the disclosed embodiments and examples is provided to enable any person skilled in the art to make or use the present invention as defined by the claims. Thus, the present invention is not intended to be limited to the examples disclosed herein. Various modifications to these embodiments will be readily apparent to those skilled in the art, and the generic principles defined herein may be applied to other embodiments without departing from the spirit or scope of the invention as claimed.

1. A drink filter system, comprising:
a disposable drink filter having a filter portion, a first flange coupled to the filter portion, and a handle; and
a reusable cartridge having a cartridge housing and a cartridge lid positioned on the housing, at least one of the housing or the lid having a second flange; wherein
the first flange is shaped and configured to align the filter relative to the cartridge;
the handle is shaped and configured to enable removal of the filter from the cartridge; and
the second flange is shaped and configured to align the lid relative to the housing.

2. The system of claim 1, wherein:
the filter portion is made of crêpe paper.

3. The system of claim 2, wherein:
the first flange is made of paper.

4. The system of claim 1, wherein:
the first flange is made of paper.

5. The system of claim 1, wherein:
the filter portion comprises one or more fill markers.

6. The system of claim 1, wherein:
the filter is made of a biodegradable material.

7. The system of claim 1, wherein:
the handle and the first flange are made of a biodegradable material.

8. The system of claim 1, wherein:
the lid is removable from the housing.

9. The system of claim 1, wherein:
the filter is made of an organic material.

10. The system of claim 1, wherein:
the filter comprises a cover; and
the filter portion and the cover are made of crêpe paper.

11. The system of claim 1, wherein:
the filter is configured to hold a maximum of 6 tablespoons of a ground or powdered ingredient for a heated drink preparation.

12. The system of claim 1, wherein:
the filter is configured to hold a maximum of 4 tablespoons of a ground or powdered ingredient for a heated drink preparation.

13. The system of claim 1, wherein:
the handle is movable between a first position and a second position relative to the filter portion; and wherein
in the first position, the handle lies against the first flange; and
in the second position, at least a portion of the handle does not contact the first flange.

14. A method of filtering a drink, comprising:
placing a disposable drink filter in a housing of a reusable cartridge, the filter having a filter portion, a first flange coupled to the filter portion, and a handle;
moving the handle between a first position and a second position wherein at least a portion of the handle does not contact the first flange; and
aligning a lid of the reusable cartridge to the housing.

15. A disposable drink filter for a drink filter system, comprising:
a filter portion;
a flange coupled to the filter portion; and
a handle; wherein
the flange is shaped and configured to align the filter relative to a cartridge in the drink filter system; and
the handle is shaped and configured to enable removal of the filter from the cartridge.

16. The filter of claim 15, wherein:
the filter portion is made of crêpe paper; and
the first flange is made of paper.

17. The filter of claim 15, wherein:
the filter comprises a cover coupled to or unitary with at least one of the filter portion or the flange.

18. The filter of claim 15, wherein:
the handle and the flange are made of paper.

19. The filter of claim 15, wherein:
the filter is configured to hold a maximum of 4 tablespoons of ground coffee.

20. The filter of claim 15, wherein:
the handle is movable between a first position and a second position relative to the filter portion; and wherein:
in the first position, the handle lies against the first flange; and
in the second position, at least a portion of the handle does not contact the flange.
